(19) United States
(12) Patent Application Publication
(10) Pub. No.: US 2021/0340070 A1
(43) Pub. Date: Nov. 4, 2021

(54) MATERIALS SYSTEMS FOR INHIBITING PENETRATION OF MOLTEN SALTS, METHODS THEREFOR, AND DEVICES PROVIDED THEREWITH

(71) Applicant: Purdue Research Foundation, West Lafayette, IN (US)

(72) Inventor: Kenneth Henry Sandhage, Lafayette, IN (US)

(21) Appl. No.: 17/220,605

(22) Filed: Apr. 1, 2021

Related U.S. Application Data
(60) Provisional application No. 63/003,746, filed on Apr. 1, 2020.

(51) Int. Cl. C04B 41/65; C04B 28/06; C04B 28/10; C04B 41/50; C04B 41/00; C09K 5/12; B01J 19/02; B01J 19/00

(52) U.S. Cl. CPC C04B 41/65; C04B 28/06; C04B 28/105; C04B 41/5001; C04B 2111/2084; C09K 5/12; B01J 19/02; B01J 19/0013; C04B 41/009

(57) ABSTRACT

Materials systems resistant to penetration of molten salts and may be present within a molten-salt-facing wall of a device for containing a molten salt bath at an elevated temperature, and molten-salt-facing walls and devices formed by such materials systems. A first layer of such a system defines an outer surface for direct contact with the molten salt bath, and resists erosion and corrosion and is penetrable by the molten salt at the elevated temperature. A second layer is located adjacent to the first layer and exhibits little or no wetting by the molten salt so that at least a portion of a thickness of the second layer is not penetrable by the molten salt. A third layer is located adjacent to the second layer and is porous and exhibits a low thermal conductivity at the elevated temperature.

### CROSS-REFERENCE TO RELATED APPLICATIONS

This application claims the benefit of U.S. Provisional Application No. 63/003,746 filed Apr. 1, 2020, the contents of which are incorporated herein by reference.

### STATEMENT REGARDING GOVERNMENT FUNDING

This invention was made with government support under Contract No. DE-EE0008375 awarded by the U.S. Department of Energy. The government has certain rights in the invention.

### BACKGROUND

This disclosure generally relates to designs, methods, and materials for inhibiting the penetration of molten salts into surfaces. In particular, this disclosure relates to designs, methods, and materials for inhibiting the penetration of molten halide salts, including but not limited to molten chloride salts, through the walls of containment devices at high temperatures. This disclosure also relates to penetration-resistant containment devices made utilizing the designs, methods, and materials of this disclosure. Such devices include, but are not limited to, piping, valves, seals, and thermal energy storage tanks for high-temperature systems, including, but not limited to, high-temperature systems for energy (e.g., electrical power) production, energy storage, waste heat recovery, and chemical processing.

This section introduces aspects that may help facilitate a better understanding of the disclosure. Accordingly, these statements are to be read in this light and are not to be understood as admissions about what is or is not prior art.

Molten salts can possess attractive characteristics for use as heat transfer liquids and as thermal energy storage liquids. Such molten salts include, but are not limited to, molten halides, molten nitrates, molten carbonates, molten sulfates, molten hydroxides, and molten oxides. Nonlimiting examples of molten halides include molten chlorides and molten fluorides.

Molten halide salts can possess particularly attractive characteristics for use as high-temperature heat transfer liquids and as high-temperature thermal energy storage liquids. Such attractive characteristics include chemical stability at high temperatures, modest melting points, low vapor pressures at high temperatures (i.e., high boiling points), modest densities, modest values of viscosity at high temperatures, and high heat capacities per unit volume.

During use as high-temperature heat transfer liquids and high-temperature thermal energy storage liquids, molten salts come into contact with a number of solid materials, including but not limited to solid materials used for containment of the molten salt in the walls of pipes and tanks. In order to allow for prolonged, cost-effective use of molten salts as high-temperature heat transfer liquids and high-temperature thermal storage liquids, the wall of a pipe or tank needs to be resistant to penetration by the molten salts at high temperatures. However, molten salts tend to wet, infiltrate, and penetrate a variety of solid materials, including solid metals, metal alloys, metal-bearing composites, ceramics, and ceramic-bearing composites. Such penetration of the molten salt into the wall of a pipe or tank can degrade desired properties of the wall and, therefore, the pipe or tank, with such properties including, but not limited to, thermal and mechanical properties. Such thermal properties include thermal conductivity. Excessive penetration of the molten salt into the walls of pipes and tanks can also lead to undesired loss of the molten salt during its use as a heat transfer liquid and thermal energy storage liquid.

Earth-abundant, low-cost molten chlorides can be particularly attractive as high-temperature heat transfer liquids and high-temperature thermal energy storage liquids, as a nonlimiting example, at temperatures above 600° C. One such group of molten chlorides are MgCl₂—KCl-bearing salts, including binary MgCl₂—KCl compositions and ternary MgCl₂—KCl—NaCl compositions. Such MgCl₂—KCl-bearing salts tend to become contaminated with oxygen-bearing species upon exposure to air at high temperatures, and form MgO or MgO-bearing species upon reaction with the oxygen or water vapor in air at high temperatures. In order to minimize such contamination and formation of MgO or MgO-bearing species, MgCl₂—KCl-bearing salts may be sealed from the air environment, and/or contained within an inert or reducing atmosphere, and/or exposed to an agent that can act to remove oxygen-bearing species from the molten salt. However, molten chloride salts including MgCl₂—KCl-bearing salts tend to wet, infiltrate, and penetrate solid materials, including solid metals, metal alloys, metal-bearing composites, ceramics, and ceramic-bearing composites. For example, structural steels exhibit appreciable corrosion by molten chlorides, particularly if the molten chlorides are contaminated with oxygen-bearing species, and porous ceramics generally exhibit appreciable molten salt penetration, particularly at temperatures of 550-750° C. or higher. These detrimental behaviors occur in inert atmospheres, including inert argon atmospheres, and in reducing atmospheres, including hydrogen-argon atmospheres. While corrosion and penetration may be addressed by using nickel-based superalloys or high-density (closed porosity) ceramics, large storage tanks and long pipe lengths comprised of these materials would be expensive.

A nonlimiting example of a system that requires containment materials that are resistant to excessive penetration by molten salts at high temperatures is a concentrated solar power (CSP) plant. Molten chloride salts, including but not limited to MgCl₂—KCl—NaCl salts, can be attractive for use as low-cost, readily available (sea-water-derived), high-temperature fluids for heat transfer (e.g., to transfer solar heat from a receiver to a working fluid through a heat exchanger, or to transfer solar heat to a thermal energy storage tank). However, excessive molten salt penetration into the wall of a pipe or tank would result in an undesired loss of the molten salts and would result in degradation of the thermal and mechanical properties of the containment materials. For example, the thermal insulation capability of a thermal energy storage tank can be significantly degraded by the excessive penetration of a molten salt into a wall of the tank (since air is a much better thermal insulator than the molten salt). Hence, the effective use of such molten salts as heat transfer media and as thermal energy storage media requires containment devices (including but not limited to pipes and thermal energy storage tanks) with molten-salt-facing walls that are: i) resistant to excessive penetration by the molten salts at high temperatures, and ii) resistant to recession or removal, such as by abrasion during installation of the containment material, or during use of the containment material, such as by erosion during use of the containment material (i.e., by erosion from contact with the flowing molten salt) or such as by thermal stresses that may be encountered during heating or cooling of the containment material. Such penetration-resistant walls of molten-salt-containment devices also need to be fabricated from inexpensive materials and need to be formed into desired shapes by cost-effective processes.

Existing methods to reduce molten salt infiltration and penetration into containment materials include: i) the use of dense (non-porous) coatings on molten-salt-facing surfaces of containment materials that prevent the penetration of a molten salt into the interiors of the containment materials, and ii) the use of non-dense coatings on molten-salt-facing surfaces of containment materials that are not wetted by a molten salt and that thereby inhibit infiltration of the molten salt into the interior of the containment materials. As a nonlimiting example, the application of a high-density graphite coating on a molten-salt-facing surface of a containment material may be considered as a means of inhibiting penetration of a molten salt (including but not limited to a molten chloride salt) into an underlying containment material. However, such coatings, or sections of such coatings, are prone to unintentional removal from a molten-salt-facing surface of a containment material during installation of the containment material, such as by abrasion during installation of the containment material, or during use of the containment material, such as by erosion during use of the containment material (i.e., by erosion from contact with the flowing molten salt), or by thermal stresses that may be encountered during heating or cooling of the coated containment material. The loss of continuity of such coatings on a molten-salt-facing surface would then provide a pathway for the infiltration and penetration of the molten salt into the containment material. Such coatings would require regular inspections to determine whether the coatings have been retained as a continuous layer within a given time, and whether the coating needs to be repaired if the coating has been partially removed. The requirement for regular inspections and regular repairs can result in undesired downtime and additional undesired costs.

Graphite plates or blocks or tubes (or other shapes) of high relative density (i.e., of low relative porosity) may also be considered as liner materials for inhibiting the penetration of a molten salt (including but not limited to a molten chloride salt) into surrounding materials. However, even such high-density graphite is prone to removal during use, such as by erosion from contact with a flowing molten salt. Graphite plates or blocks or tubes (or other shapes) of high relative density (i.e., of low relative porosity) are also expensive, owing to the high temperatures required to fire their graphite materials in order to obtain a high relative density (and low relative porosity).

Thus, there is an unmet need for cost-effective designs, materials, and fabrication methods for the containment of molten salts that would avoid excessive penetration of molten salts at high temperatures into the walls of the containment devices and provide containment devices with walls that are resistant to recession or removal, such as by abrasion during installation of the containment material, or during use of the containment material, such as by erosion during use of the containment material (i.e., by erosion from contact with the flowing molten salt) or such as by thermal stresses that may be encountered during heating or cooling of the containment material.

### BRIEF SUMMARY OF THE INVENTION

The present invention provides materials systems that are resistant to penetration of molten salts and may be present within a molten-salt-facing wall of a device for containing a molten salt bath at an elevated temperature and provides methods for producing such materials systems and molten-salt-facing walls and devices formed by such materials systems.

According to one aspect of the invention, a materials system is provided that is resistant to penetration of a molten salt. The materials system is present within a molten-salt-facing wall of a device for containing a molten salt bath at an elevated temperature. The materials system includes a first layer that comprises a first material and defines an outer surface of the materials system for direct contact with the molten salt bath. The first layer possesses resistance to erosion in the molten salt at the elevated temperature, possesses resistance to corrosion in the molten salt at the elevated temperature, and is penetrable by the molten salt at the elevated temperature. The materials system further includes a second layer that comprises a second material and is located adjacent to the first layer, such that the first layer is located between the second layer and the outer surface of the materials system. The second layer exhibits little or no wetting by the molten salt so that at least a portion of a thickness of the second layer is not penetrable by the molten salt. The materials system further includes a third layer that comprises a third material and is located adjacent to the second layer. The third layer is porous and exhibits a low thermal conductivity at the elevated temperature.

Other aspects of the invention include methods of producing the materials system as described above, as well as devices that comprise the materials system and molten-salt-facing walls comprising the materials system.

Aspects and advantages of this invention will be appreciated from the following detailed description.

### BRIEF DESCRIPTION OF DRAWINGS

Some of the drawings shown herein may have been created from scaled drawings or from photographs that are scalable. It is understood that dimensions or relative scaling within a drawing are by way of example, and not to be construed as limiting. Further, in this disclosure, the drawings are shown for illustrative purposes and not to scale, and those skilled in the art can readily recognize the relative dimensions of different drawings depending on how the principles of the disclosure are used in practical applications.

FIGS. 1A and 1B provide top-down photographs of, respectively, a cast, porous calcium aluminate-based ceramic crucible (WAM AL II-HD, overall Al₂O₃:CaO molar ratio of 4.0:1.0, Westmoreland Advanced Materials, Inc., Charleroi, Pa.) that had been heated at a peak temperature of 750° C. for 5 h in air, and a 750° C.-fired WAM AL II-HD crucible after exposure to a molten MgCl₂—KCl—NaCl salt at a peak temperature of 750° C. for 2 h in industrial-grade argon. The fired, cube-shaped crucibles in FIGS. 1A and 1B possessed an edge length of 4.6 cm and a cavity diameter of 7.6 mm.

FIGS. 2A and 2B provide top-down photographs of, respectively, a porous calcium aluminate-based ceramic crucible (WAM BLG, overall Al₂O₃:CaO molar ratio of 5.9:1.0, Westmoreland Advanced Materials, Inc.) that had been heated at a peak temperature of 750° C. for 5 h in air, and the same WAM BLG porous ceramic crucible from FIG. 2A after exposure to a molten MgCl₂—KCl—NaCl salt at a peak temperature of 750° C. for 2 h in industrial grade argon. These cube-shaped crucibles possessed an edge length of 7.1 cm and a cavity diameter of 20 mm.

FIG. 3 provides a schematic illustration of a design concept utilizing a nonlimiting embodiment of this invention, which is to provide the wall of a containment device (including but not limited to the wall of a tank or the wall of a pipe) in contact with a flowing or stagnant molten salt, with the wall comprising: a rigid, erosion-resistant, and corrosion-resistant solid layer (A) at the molten-salt-facing surface that is wetted by, and penetrated by, the molten salt; a highly-porous thermally insulating layer (C); and a solid layer (B) that is not wetted or penetrated by the molten salt and located between layers (A) and (C). The layer (A) is used to provide erosion resistance to the wall of the containment device and to provide a porous layer within the pores of which the molten salt will tend to reside, as the solid in this layer is wetted by the molten salt. The layer (B), which is not wetted by the molten salt, is used to inhibit migration of the molten salt into the highly porous layer (C).

FIG. 4 provides a schematic illustration of an example of the design concept shown in FIG. 3, in which layer (A) is a cast and fired porous WAM BLG layer (a porous calcium hexa-aluminate (CaAl₁₂O₁₉, “CA₆”) based ceramic layer) at the molten-salt-facing surface that is wetted by, and penetrated by, molten MgCl₂—KCl—NaCl salt at 750° C. in an argon atmosphere, layer (C) is a highly-porous fibrous aluminosilicate, and layer (B) is a porous layer of packed graphite granules that is not wetted or penetrated by the molten salt molten MgCl₂—KCl—NaCl salt at 750° C. The WAM BLG layer is a castable porous CaAl₁₂O₁₉-based layer that is wetted by molten MgCl₂—KCl—NaCl salt at 750° C. (as shown in FIGS. 2A and 2B). Graphite in layer (B) was determined to not be wetted, and to not be penetrated, by molten MgCl₂—KCl—NaCl salt at 750° C.

FIG. 5 provides a schematic illustration of a design concept utilizing another nonlimiting embodiment of this invention, in which the wall of FIG. 3 further includes additional layers (A) and (B) as alternating adjacent layers between the layers (B) and (C) to provide additional barriers that are resistant to wetting and penetration by the molten salt, so as to provide extra protection against penetration of the molten salt into the thermal insulation layer (C).

FIG. 6 provides a schematic illustration of an example of the design concept shown in FIG. 5, in which each layer (A) is a porous MgO layer that can be wetted by, and penetrated by, molten CaCl₂)—NaCl-based salt at 750° C. in an argon or air atmosphere, layer (C) is a highly-porous thermally insulating layer of fibrous aluminosilicate, and each layer (B) is a packed layer of graphite flakes that is not wetted or penetrated by the molten CaCl₂)—NaCl-based salt at 750° C. in an argon or air atmosphere.

### DETAILED DESCRIPTION OF THE INVENTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the principles of the disclosure, and such further applications of the principles of the disclosure as illustrated therein being contemplated as would normally occur to one skilled in the art to which the disclosure relates.

The present invention provides materials systems suitable for use as walls of molten-salt-containment devices to inhibit excessive penetration of molten salts at high temperatures into the walls of the molten-salt-containment devices, and thereby to provide the walls of molten-salt-containment devices with desired thermal, chemical, and mechanical properties. The present invention also provides methods of producing the materials systems, as well as molten-salt-facing walls and devices that make use of the materials systems. The materials systems generally utilize a multilayer wall comprising one or more layers of a rigid, chemically robust, porous ceramic compound that provides resistance to erosion by molten chloride salts, alternating with one or more porous layers comprising a carbon particulate material that provides resistance to molten chloride penetration. Material systems comprising layers of such materials may be fabricated by relatively low-cost casting processes. High temperatures of interest will depend on the particular application. For applications involving the use of high-temperature heat transfer liquids and high-temperature thermal energy storage liquids, high temperatures of interest are typically above 600° C. and often above 750° C. However, it is foreseeable that other applications may benefit from the materials systems described below, and that operating temperatures for such applications may be above 25° C., for example, above 100° C., above 300° C., above 500° C., above 700° C., above 750° C., or above 1000° C.

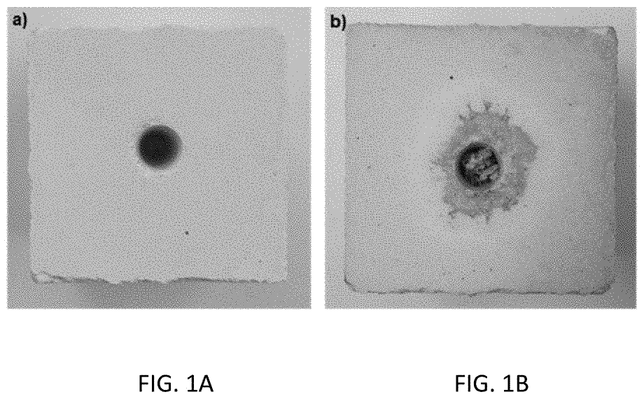

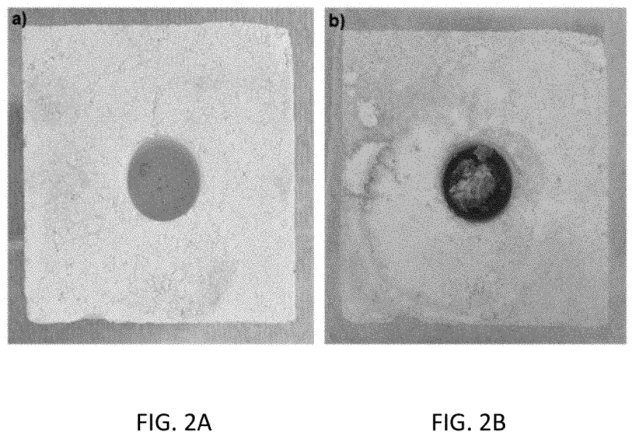

In studies leading to this disclosure, a molten MgCl₂—KCl—NaCl salt was determined to infiltrate porous cast CaO—Al₂O₃-based ceramics in an argon atmosphere at 750° C. Photographs of porous CaO—Al₂O₃-based ceramic crucibles, before and after exposure to a molten MgCl₂—KCl—NaCl salt, are shown in FIGS. 1A, 1B, 2A, and 2B.

FIGS. 1A and 1B show ceramic crucibles comprising a castable calcium-aluminate-based ceramic composition (WAM ALII-HD, Westmoreland Advanced Materials, Inc., Charleroi, Pa.). This ceramic material possessed an overall Al₂O₃:CaO molar ratio of 4.0:1.0 and contained sintered calcium hexa-aluminate (“CA₆,” CaAl₁₂O₁₉) grains bonded with fine cement powder comprising calcium monoaluminate (CaAl₂O₄) and calcium dialuminate (CaAl₄O₇), along with some BaSO₄. The ceramic crucibles shown in FIGS. 1A and 1B were formed by casting a slurry of the ceramic material in water, and then curing the cast crucibles in a humid atmosphere at 35° C. for 24 h and then heating in ambient air to 110° C. for another 24 h. The resulting ceramic crucibles were then heated at 50° C./h to 750° C. for 5 h in air, and then cooled at 180° C./h. A solid MgCl₂—KCl—NaCl salt with a composition of 38.8 mol % MgCl₂, 41.2 mol % KCl, and 20 mol % NaCl was prepared and heated to 750° C. for 30 min in an industrial-grade argon atmosphere (oxygen partial pressure=po₂=10² ppm) in a graphite crucible and then cooled at 180° C./h to room temperature. After resolidification of the molten salt, the graphite crucible was determined to have not been wetted by, and not to have been penetrated by, the molten MgCl₂—KCl—NaCl salt during exposure to this salt for 30 min at 750° C. The solidified salt was then added to the cavity in one of the ceramic crucibles. To evaluate the infiltration and penetration of the molten MgCl₂—KCl—NaCl salt into the porous ceramic crucible, the ceramic crucible and its solid MgCl₂—KCl—NaCl salt-bearing contents were heated in an industrial-grade argon atmosphere (po₂=10² ppm) to 750° C. at 100° C./h, held for 2 h at 750° C., and then cooled at 180° C./h to room temperature. FIG. 1B shows the ceramic crucible after such exposure. The observed discoloration surrounding the cavity of the ceramic crucible indicated that the molten MgCl₂—KCl—NaCl salt had penetrated an appreciable distance (up to roughly 8 mm) within only 2 h at a peak temperature of 750° C.

FIGS. 2A and 2B show ceramic crucibles comprising a castable calcium-aluminate-based ceramic composition (WAM BLG, Westmoreland Advanced Materials, Inc., Charleroi, Pa.). This ceramic material possessed an overall Al₂O₃:CaO molar ratio of 5.9:1.0 and contained calcium hexa-aluminate (CaAl₁₂O₁₉), along with calcium monoaluminate/dialuminate cement (CaAl₂O₄/CaAl₄O₇) with alumina (Al₂O₃). The ceramic crucibles shown in FIGS. 2A and 2B were formed by casting, in a similar manner as described above for FIGS. 1A and 1B. The ceramic crucibles were then heated at 50° C./h to 750° C. for 5 h in air, and then cooled at 180° C./h. A solid MgCl₂—KCl—NaCl salt with a composition of 38.8 mol % MgCl₂, 41.2 mol % KCl, and 20 mol % NaCl was prepared in a similar manner as described above. The solidified salt was then added to the cavity in one of the ceramic crucibles. To evaluate the infiltration and penetration of the molten MgCl₂—KCl—NaCl salt into the porous ceramic crucible, the ceramic crucible and its solid MgCl₂—KCl—NaCl salt contents were heated in an industrial-grade argon atmosphere (poₜ=10² ppm) to 750° C. at 100° C./h, held for 2 h at 750° C., and then cooled at 180° C./h to room temperature. FIG. 2B shows the ceramic crucible after such exposure. The observed discoloration surrounding the cavity of the ceramic crucible indicated that the molten salt had penetrated an appreciable distance within only 2 h at a peak temperature of 750° C. After removing the residual solidified salt from the crucible cavity, and after factoring out the mass loss due to salt evaporation, the WAM BLG crucible specimen was determined to have exhibited a mass gain of 8.87 g, which corresponded to the penetration of 93.2% of the non-evaporated salt into the WAM BLG crucible specimen during exposure of this crucible to the MgCl₂—KCl—NaCl salt for only 2 h at a peak temperature of 750° C.

In further studies leading to this disclosure, additional ceramic crucibles and solid chloride salt compositions were prepared and investigated. In these studies, MgCl₂ (anhydrous, 99.0% purity), KCl (99.9% purity), and NaCl (99.0% purity) were used to prepare MgCl₂—KCl—NaCl salt mixtures. A calcium hexa-aluminate (CA₆) based castable composition (BLG, 5.9:1 Al₂O₃:CaO molar ratio, Westmoreland Advanced Materials, Inc., Charleroi, Pa., USA) was used to generate rigid, porous ceramic crucibles. Synthetic graphite particles (K106 grade, ≥99.0% purity, ≥89% with sizes between 149 μm (100 mesh) and 840 μm (20 mesh) (Carbon Graphite Materials, Inc., Brocton, N.Y., USA) were used to generate packed particulate-based layers.

The MgCl₂—KCl—NaCl salt mixtures were prepared to contain 40 mol % MgCl₂, 40 mol % KCl, and 20 mol % NaCl was prepared by mixing and melting the pure chloride salt components. The ceramic crucibles formed of calcium hexa-aluminate were prepared by casting to produce crucibles of two different sizes, with smaller crucibles sized to fit within cavities of the larger crucibles such that a gap is present between and completely separates the two crucibles. The cast crucibles were cured for 20 h at 35° C. in a water-vapor-saturated atmosphere within a sealed oven, then heated for an additional 24 h at 110° C. in air. The cast cured crucibles were then heated at 100° C./h to a peak temperature of 750° C. in industrial grade Ar and held at this temperature for 24 h, yielding porous calcium hexa-aluminate-based crucibles.

A multilayer materials system was then formed for containment of the MgCl₂—KCl—NaCl salt mixture. The material system included one each of the smaller and larger calcium hexa-aluminate-based ceramic crucibles, with the smaller crucible placed within the cavity of the larger crucible and a packed graphite particulate layer provided within the gap between the two crucibles. Prior to testing, an amount of the MgCl₂—KCl—NaCl salt mixture was premelted and placed within the cavity of the smaller crucible, which was then heated in flowing industrial-grade (99.99% purity) Ar at 100° C./h to 750° C. and held at the latter temperature for 2 h. After cooling to room temperature, weight change measurements indicated that the smaller crucible contained 18.3 grams of solidified salt. A layer of graphite powder of approximately 9 mm thickness was then deposited within the cavity of the larger crucible and vibrated before placing the salt-bearing smaller crucible (from the previous step) within the cavity of the larger crucible and on the layer of graphite powder. The remaining gap between the walls of the smaller (inner) and larger (outer) crucibles was then filled with graphite powder and the whole assembly was vibrated. Weight measurements indicated that a total of 83.9 grams of graphite powder was present within the gaps between the inner and outer crucibles.

A molten salt penetration experiment was then conducted. For this experiment, an additional amount (21.9 grams) of the MgCl₂—KCl—NaCl salt mixture was placed inside the cavity of the inner crucible and the entire assembly (the inner and outer crucibles and the graphite powder therebetween) was heated in flowing industrial-grade Ar at 100° C./h to 750° C. and held at the latter temperature for 24 h. After cooling to room temperature, weight measurements of the entire assembly indicated that the remaining salt content contained within the assembly was 37.8 grams (i.e., 2.4 grams of the salt had been lost by evaporation). The graphite powder separating the inner and outer crucibles remained loose and was easily removed from the assembly, with no appreciable increase in apparent agglomeration due to salt penetration into the graphite powder. The graphite powder weighed 80.9 grams, which was 3.0 grams (3.6%) less than the weight of the graphite powder that had been placed in the assembly prior to the experiment. This weight loss was attributed to the graphite powder remaining attached to the inner surfaces of the outer crucible and the outer surfaces of the inner crucible. The outer crucible weighed 0.5 grams more than what the outer crucible weighed prior to the experiment, and the inner crucible weighed 2.4 grams more than what the inner crucible previously weighed (after considering the weight of the salt remaining in the inner crucible after the 24 h test at 750° C.). Hence, the combined weight of the graphite remaining attached to the crucibles (2.9 g) and the graphite removed from the assembly (80.9 g) was close to the weight of the graphite powder originally placed in the assembly (83.8 g vs. 83.9 g, respectively). Hence, it was concluded that no appreciable weight gain of the graphite powder occurred due to penetration of the molten salt through the inner crucible and into the graphite layer.

X-ray diffraction analysis was used to determine whether any molten salt had penetrated into the graphite powder. Three graphite powder batches extracted from the assembly after the experiment did not exhibit any detectable diffraction peaks from the salt. The absence of any detectable salt in the extracted graphite powder demonstrated that the experimental materials system was effective for preventing molten salt penetration into the intermediate graphite powder layer as well as the porous outer crucible, such that the performance of these layers of the materials system would not have been adversely affected by the molten salt.

On the basis of the experiments, it is believed that similar or equivalent results can be obtained with other materials used for the crucibles and intermediate layer separating them. Another group of molten chlorides is CaCl₂)—NaCl-bearing salts, including binary CaCl₂)—NaCl compositions, ternary CaCl₂)—NaCl—BaCl₂, and quaternary CaCl₂)—NaCl—BaCl₂—KCl compositions. Such CaCl₂)—KCl-bearing salts tend to wet, infiltrate, and penetrate solid materials, including solid metals, metal alloys, metal-bearing composites, ceramics, and ceramic-bearing composites in air, in inert atmospheres, including inert argon atmospheres, and in reducing atmospheres, including hydrogen-argon atmospheres. However, it was determined that molten CaCl₂)—NaCl-bearing salts do not wet, and do not penetrate into, graphite crucibles at 750° C.

Molten salts of particular interest include, but are not limited to, any one of the following materials or any combinations of the following materials: halide-bearing liquids, nitrate-bearing liquids, carbonate-bearing liquids, sulfate-bearing liquids, hydroxide-bearing liquids, and oxide-bearing liquids. Such molten halides include, but are not limited to, chloride-bearing liquids and fluoride-bearing liquids.

Molten-salt-containment devices of particular interest include, but are not limited to, pipes, valves, seals, and thermal energy storage tanks.

The present invention provides high-temperature systems utilizing the methods, materials, and designs of the walls of molten-salt-containment devices, with such methods, materials, and designs providing resistance to excessive penetration of molten salts at high temperatures into the walls of the molten-salt-containment devices, and thereby providing the walls of the molten-salt-containment devices with desired thermal, chemical, and mechanical properties. Examples of such high-temperature systems include, but are not limited to, systems for energy (e.g., electrical power) production, energy storage, waste heat recovery, and chemical processing. Examples of electrical power production systems in the context of this invention include, but are not limited to, systems for fossil fuel-based electricity generation, solar energy-based electricity-generation, hydrothermal energy-based electricity generation, and nuclear energy-based electricity generation. Solar energy-derived power production systems in the context of this invention include but not limited to concentrating solar power production systems.

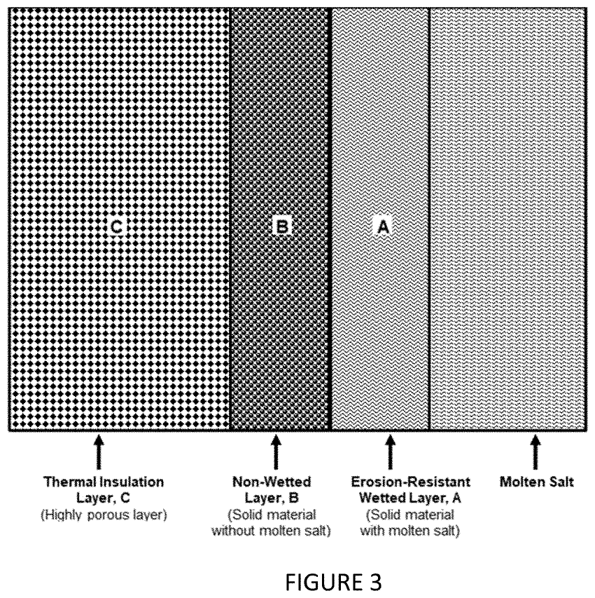

A nonlimiting embodiment of a wall of a molten-salt-containment device of the present invention is schematically represented in FIG. 3. Based on the experiments described above, multiple layers are used to produce the wall having the desired combination of resistance to molten salt penetration, resistance to erosion and corrosion in the flowing molten salt, and resistance to heat transport. A first layer (“A”) of the three layers represented in FIG. 3 is positioned closest to the molten salt and may define a surface that contacts the molten salt (e.g., corresponding to the inner crucible of the experiments). Layer A contains a material that possesses, or contains a mixture of materials that possess, resistance to erosion and resistance to corrosion by the flowing or stagnant molten salt at elevated temperatures. Resistance to corrosion by the molten salt in this invention refers to resistance to chemical and physical degradation by the molten salt, which may cause a decrease in the thickness of the layer A with time at the elevated temperature due to a chemical reaction with a molten salt bath. Resistance to corrosion includes, but is not limited to, resistance to chemical reaction to form new solid or liquid products and resistance to congruent or incongruent dissolution in the molten salt. The layer A contains one or more materials that are wetted by the molten salt at elevated temperatures, so that the molten salt penetrates into the layer A. Such molten salt penetration into layer A may occur by penetration of the molten salt into one or more of pores within layer A, grain boundaries within layer A, and interphase boundaries within layer A. A second layer (“B”) in FIG. 3 contains a material that exhibits, or contains a mixture of materials that exhibit, little or no wetting by the molten salt, so that the molten salt exhibits little or no infiltration into layer B, and so that the molten salt does not penetrate completely through the thickness of layer B. The third layer (“C”) in FIG. 3 contains a highly porous material that exhibits, or contains a highly porous mixture of materials that exhibit, low thermal conductivity.

By providing a layer A that is rigid and resistant to erosion by the flowing molten salt, layer B (e.g., corresponding to the intermediate layer of the experiments) is able to contain a material that is not erosion resistant (since layer B is not exposed to the flowing molten salt). Layer B may contain a lower-cost material, or a lower-cost mixture of materials. Layer B may contain materials with forms selected from a list including, but not limited to, solid particles and hollow particles. Such solid and hollow particles may possess shapes including, but not limited to, spheres, fibers, flakes, platelets, and irregular shapes.

By providing a layer A containing one or more materials that is/are wetted by the molten salt at elevated temperatures, and a layer B that contains one or more materials that exhibit little or no wetting by the molten salt, there is a thermodynamic driving force to retain the molten salt in layer A (since the salt prefers to wet the material or materials in layer A).

By providing a layer C (e.g., corresponding to the outer crucible of the experiments) containing a highly porous material that exhibits, or contains a highly porous mixture of materials that exhibit, low thermal conductivity, the wall of the containment device can be thermally insulating, that is, a low rate of heat loss can be achieved through the wall of such a containment device, so that the heat can be retained in the flowing or stagnant molten salt bath.

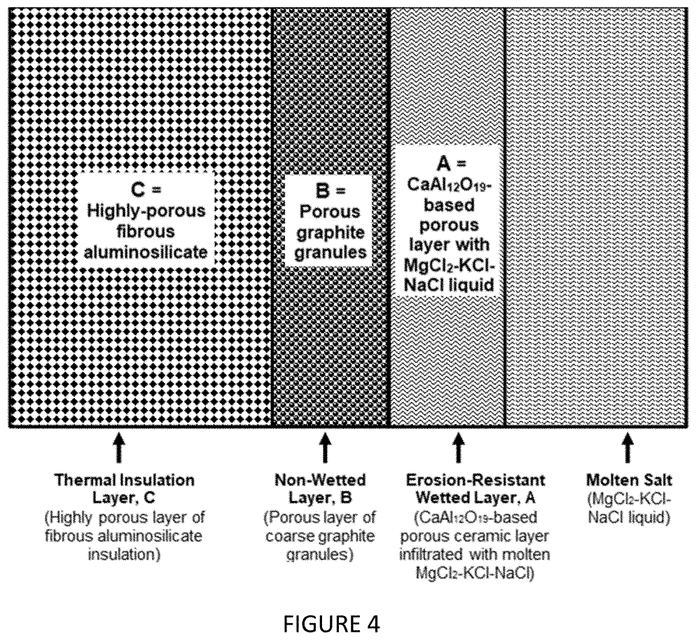

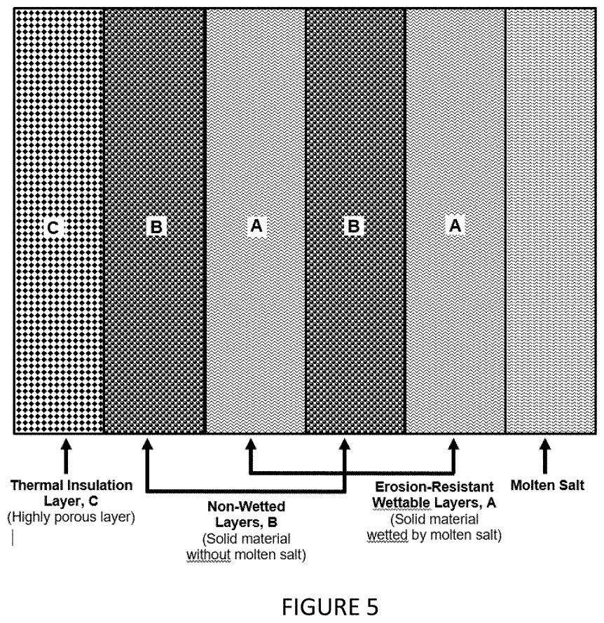

Another nonlimiting embodiment of a wall of a molten-salt-containment device of the present invention is schematically represented in FIG. 5. The wall differs from that of FIGS. 3 and 4 by further containing additional layers of layers A and B. Multiple layers of layer B are provided in the event that the layer B closest to the molten salt bath exhibits a failure, so that the molten salt penetrates past this layer B closest to the molten salt bath. The multiple layers of A and B may be more than just the two layers of A and two layers of B shown in FIG. 5.

The following description provides specific examples of the above general concepts of this disclosure with reference to several solid materials, alloys, ceramics, and liquids. These are merely exemplary embodiments and are not intended to limit the scope of this disclosure.

The layers A in FIG. 3 and in FIG. 5 contain a material that possesses, or contain a mixture of one or more materials that possess, resistance to erosion and resistance to corrosion by the flowing or stagnant molten salt at elevated temperatures, and that is or are wetted and penetrated by the molten salt, including, but not limited to, metals, metallic alloys, metal-bearing composites, ceramics, and ceramic-bearing composites; porous metals, porous metallic alloys, porous metal-bearing composites, porous ceramics, and porous ceramic-bearing composites; and porous oxides, porous nitrides, porous carbides, porous sulfides, porous borides, porous oxide-bearing composites, porous nitride-bearing composites, porous carbide-bearing composites, porous sulfide-bearing composites, and porous boride-bearing composites.

The layers B in FIG. 3 and in FIG. 5 contain a material that exhibits, or contain a mixture of materials that exhibit, little or no wetting by the molten salt, so that the molten salt exhibits little or no infiltration into layer B, and so that the molten salt does not penetrate completely through layer B. Such a non-wetted solid or non-wetted mixture of solids in layers B in FIG. 3 and in FIG. 5 includes, but is not limited to, one or more hydrophobic solids, including but is not limited to hydrophobic oxide compounds, hydrophobic carbide compounds, hydrophobic boride compounds, hydrophobic nitride compounds, and hydrophobic phosphide compounds. For example, the non-wetted solid or non-wetted mixture of solids in layers B in FIG. 3 and in FIG. 5 include, but are not limited to, hydrophobic oxygen-bearing compounds, hydrophobic carbon-bearing compounds, hydrophobic hydrocarbon-bearing compounds, hydrophobic boron-bearing compounds, hydrophobic nitrogen-bearing compounds, and hydrophobic phosphorus-bearing compounds. Particular but nonlimiting examples include hydrophobic scandium-bearing compounds, hydrophobic yttrium-bearing compounds, hydrophobic lanthanum-bearing compounds, hydrophobic cerium-bearing compounds, hydrophobic praseodymium-bearing compounds, hydrophobic neodymium-bearing compounds, hydrophobic promethium-bearing compounds, hydrophobic samarium-bearing compound, hydrophobic europium-bearing compounds, hydrophobic gadolinium-bearing compounds, hydrophobic terbium-bearing compounds, hydrophobic dysprosium-bearing compounds, hydrophobic holmium-bearing compounds, hydrophobic thulium-bearing compounds, hydrophobic ytterbium-bearing compounds, and hydrophobic lutetium-bearing compounds.

Suitable non-wetted solids or non-wetted mixtures of solids for use in layers B in FIG. 3 and in FIG. 5 further include, but are not limited to, carbon-bearing solids, hydrocarbon-bearing solids, mixtures of one or more carbon-bearing solids, mixture of one or more hydrocarbon-bearing solids, and mixtures of one or more carbon-bearing solids and one or more hydrocarbon-bearing solids. Such non-wetted solids or non-wetted mixture of solids for use in layers B in FIG. 3 and in FIG. 5 may be amorphous or partially amorphous. Particular examples include graphite-bearing solids, graphite-coated solids, carbon-coated solids, hydrocarbon-coated solids, mixtures of one or more carbon-coated solids, mixtures of one or more hydrocarbon-coated solids, mixtures of one or more carbon-coated solids and one or more hydrocarbon-coated solids, carbon-bearing solids produced from pitch, tar, or a mixture of pitch and tar, hydrocarbon-bearing solids produced from pitch, tar, charcoal, or a mixture of two or more of pitch, tar, and charcoal, carbon-bearing solids obtained or produced from a natural source or a manufactured source (including but not limited to plants, peat, coal, coal tar, and petroleum).

Any of the non-wetted solids and non-wetted mixtures of solids described above for layers B in FIG. 3 and in FIG. 5 may be solid particles and/or hollow particles, and may have various shapes, including but not limited to, spheres, fibers, flakes, platelets, and irregular shapes.

The layer C in FIG. 3 and in FIG. 5 contains a highly porous material that exhibits, or contains a highly porous mixture of materials that exhibit, low thermal conductivity, including, but not limited to, highly porous metals, highly porous metallic alloys, highly-porous metal-bearing composites, highly-porous ceramics, and highly-porous ceramic-bearing composites.

One example of the general design concept of the wall of a molten-salt-containment device of the present invention shown in FIG. 3 is represented in FIG. 4. In this example, the molten salt is a MgCl₂—KCl—NaCl liquid (with a composition of 38.8 mol % MgCl₂, 41.2 mol % KCl, and 20 mol % NaCl). The layer A in FIG. 4 that is positioned closest to this molten salt contains a cast and fired (to a peak temperature of 750° C. for 5 hours in air) porous WAM BLG layer (comprising a porous calcium hexa-aluminate, CaAl₁₂O₁₉, based ceramic layer) that is infiltrated with the MgCl₂—KCl—NaCl liquid. As revealed in FIGS. 2A and 2B, this cast and fired WAM BLG ceramic material is readily wetted and penetrated by this MgCl₂—KCl—NaCl liquid at 750° C. in argon. Related investigations have also demonstrated that this rigid (erosion-resistant) WAM BLG material is highly resistant to corrosion by this MgCl₂—KCl—NaCl liquid at 750° C. in argon (that is, this WAM BLG material exhibits negligible reaction with this MgCl₂—KCl—NaCl liquid at 750° C. in argon). The layer B in FIG. 4 contains a porous layer of coarse graphite granules. Related investigations have demonstrated that graphite exhibits negligible wetting and penetration by this MgCl₂—KCl—NaCl liquid at 750° C. in argon. Such a layer of coarse graphite granules is notably less expensive than a layer of dense (low porosity) graphite, owing to the high sintering temperatures required to generate dense (low porosity) graphite. The layer C in FIG. 4 contains a highly porous layer of fibrous aluminosilicate insulation that possesses a low thermal conductivity at 750° C.

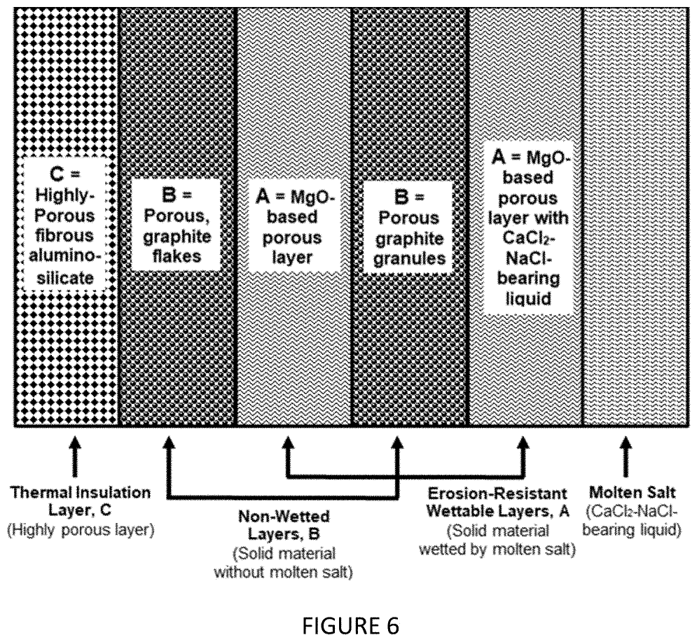

One example of the general design concept of the wall of a molten-salt-containment device of the present invention shown in FIG. 5 is represented in FIG. 6. In this example, the molten salt is a CaCl₂)—NaCl-bearing liquid (with a composition of 53 mol % CaCl₂), 47 mol % NaCl). The layer A in FIG. 6 that is positioned closest to this molten salt contains rigid and porous MgO. Related investigations have shown that porous MgO is readily wetted and can be penetrated by this CaCl₂)—NaCl liquid at 750° C. in argon or in air. MgO is also resistant to erosion by flowing CaCl₂)—NaCl liquid at 750° C. in argon or in air. Related investigations have also demonstrated that such rigid (erosion-resistant) porous MgO is resistant to corrosion by this CaCl₂)—NaCl liquid at 750° C. in argon or in air (that is, MgO exhibits negligible reaction with this CaCl₂)—NaCl liquid at 750° C. in argon or in air). The layer B in FIG. 6 contains a porous layer of packed coarse graphite flakes. Related investigations have demonstrated that graphite exhibits negligible wetting and penetration by this CaCl₂)—NaCl liquid at 750° C. in argon. Such a layer of graphite flakes is notably less expensive than a layer of dense (low porosity) graphite, owing to the high sintering temperatures required to generate dense (low porosity) graphite. The layer C in FIG. 6 contains a highly porous layer of fibrous aluminosilicate insulation that possesses a low thermal conductivity at 750° C.

The present disclosure is believed to describe cost-effective designs, materials systems, and fabrication methods for the containment of molten salts, and that such materials systems are capable of inhibiting or preventing penetration of molten salts at high temperatures into the walls of containment devices. Furthermore, the materials systems are believed to be resistant to recession or removal, such as by abrasion during installation of the containment material, or during use of the containment material, such as by erosion during use of the containment material (i.e., by erosion from contact with the flowing molten salt) or such as by thermal stresses that may be encountered during heating or cooling of the containment material. Based on experimental results, it is believed that the first layers (layer A) of the materials systems may be capable of exhibiting recession rates of 100 microns per year or less, possibly as low as 10 microns per year.

While the present disclosure has been described with reference to certain embodiments, it will be apparent to those of ordinary skill in the art that other embodiments and implementations are possible that are within the scope of the present disclosure without departing from the spirit and scope of the present disclosure. For example, the materials comprising layers A, B, and C in the design of FIG. 3 and in the design of FIG. 5 could be formed utilizing materials other than those noted, and could be used in high-temperature applications other than those described. The molten salts could contain materials other than those noted. The non-wetted solids could contain materials other than those noted. Accordingly, it should be understood that the disclosure is not limited to any embodiment described herein. It should also be understood that the phraseology and terminology employed above are for the purpose of describing the disclosed embodiments, and do not necessarily serve as limitations to the scope of the disclosure.

1. A materials system that is resistant to penetration of a molten salt, the materials system being present within a molten-salt-facing wall of a device for containing a molten salt bath at an elevated temperature, the materials system comprising:
a first layer comprising a first material and defining an outer surface of the materials system for direct contact with the molten salt bath, the first layer possessing resistance to erosion in the molten salt at the elevated temperature, and possessing resistance to corrosion in the molten salt at the elevated temperature, the first layer being penetrable by the molten salt at the elevated temperature;
a second layer comprising a second material and located adjacent to the first layer, the first layer located between the second layer and the outer surface of the materials system, the second layer exhibiting little or no wetting by the molten salt so that at least a portion of a thickness of the second layer is not penetrable by the molten salt; and
a third layer comprising a third material and located adjacent to the second layer, the third layer being porous and exhibiting a low thermal conductivity at the elevated temperature.

2. The materials system of claim 1, wherein the elevated temperature is above 600° C.

3. The materials system of claim 1, wherein the molten salt is selected from the group consisting of a halide-bearing liquid, a nitrate-bearing liquid, a carbonate-bearing liquid, a sulfate-bearing liquid, a hydroxide-bearing liquid, and an oxide-bearing liquid.

4. The materials system of claim 3, wherein the molten salt is the halide-bearing liquid selected from the group consisting of a chloride-bearing liquid and a fluoride-bearing liquid.

5. The materials system of claim 4, wherein the molten salt is the chloride-bearing liquid selected from the group consisting of a MgCl₂—KCl—NaCl-bearing liquid and a CaCl₂)—NaCl-bearing liquid.

6. The materials system of claim 1, wherein the corrosion or erosion of the first layer in the molten salt bath at the elevated temperature results in recession of the first layer of less than 10 micrometers per year.

7. The materials system of claim 1, wherein the corrosion or erosion of the first layer in the molten salt bath at the elevated temperature results in recession of the first layer of less than 100 micrometers per year.

8. The materials system of claim 1, wherein the first material of the first layer is selected from the group consisting of a metal, a metallic alloy, a metal-bearing composite, a ceramic, and a ceramic-bearing composite.

9. The materials system of claim 8, wherein the first material is porous.

10. The materials system of claim 8, wherein the first material is selected from the group consisting of a porous oxide, a porous nitride, a porous carbide, a porous sulfide, and a porous boride.

11. The materials system of claim 8, wherein the first layer contains a mixture of the first material and at least an additional material selected from the group consisting a metal, a metallic alloy, a metal-bearing composite, a ceramic, and a ceramic-bearing composite.

12. The materials system of claim 11, wherein the first material is porous.

13. The materials system of claim 11, wherein the additional material is porous.

14. The materials system of claim 11, wherein the first material and the additional material are porous.

15. The materials system of claim 11, wherein the first material and the additional material are selected from the group consisting of a porous oxide, a porous nitride, a porous carbide, a porous sulfide, and a porous boride.

16. The materials system of claim 1, wherein the second material of the second layer is a hydrophobic solid.

17. The materials system of claim 1, wherein the second material of the second layer is selected from the group consisting of an oxygen-bearing compound, a carbon-bearing compound, a hydrocarbon-bearing compound, a boron-bearing compound, a nitrogen-bearing compound, and a phosphorus-bearing compound.

18. The materials system of claim 1, wherein the second material of the second layer is at least partially amorphous.

19. The materials system of claim 1, wherein the second material of the second layer is selected from the group consisting of a scandium-bearing compound, a yttrium-bearing compound, a lanthanum-bearing compound, a cerium-bearing compound, a praseodymium-bearing compound, a neodymium-bearing compound, a promethium-bearing compound, a samarium-bearing compound, a europium-bearing compound, a gadolinium-bearing compound, a terbium-bearing compound, a dysprosium-bearing compound, a holmium-bearing compound, a thulium-bearing compound, a ytterbium-bearing compound, and a lutetium-bearing compound.

20. The materials system of claim 1, wherein the second layer contains an additional material selected from the group consisting of a carbon-bearing solid, a hydrocarbon-bearing solid, a mixture of one or more carbon-bearing solids, a mixture of one or more hydrocarbon-bearing solids, and a mixture of one or more carbon-bearing solids and one or more hydrocarbon-bearing solids.

21. The materials system of claim 20, wherein the additional material is amorphous.

22. The materials system of claim 1, wherein the second material of the second layer is selected from the group consisting of a graphite-bearing solid, and a graphite-coated solid.

23. The materials system of claim 1, wherein the second material of the second layer is selected from the group consisting of a carbon-coated solid, a hydrocarbon-coated solid, a mixture of one or more carbon-coated solids, a mixture of one or more hydrocarbon-coated solids, and a mixture of one or more carbon-coated solids and one or more hydrocarbon-coated solids.

24. The materials system of claim 1, wherein the second material of the second layer is a carbon-bearing solid material produced from pitch, produced from tar, or produced from a mixture of pitch and tar.

25. The materials system of claim 1, wherein the second material of the second layer is a hydrocarbon-bearing solid material produced from pitch, produced from tar, or produced from a mixture of pitch and tar.

26. The materials system of claim 1, wherein the second material of the second layer is a carbon-bearing solid material selected from the group consisting of a carbon-bearing solid obtained or produced from a natural source and a carbon-bearing solid obtained or produced from a manufactured source.

27. The materials system of claim 26, wherein the natural source and the manufactured source are selected from the group consisting of plants, algae, peat, coal, coal tar, and petroleum.

28. The materials system of claim 1, wherein the second material of the second layer is a solid material selected from the group consisting of solid particles and hollow particles.

29. The materials system of claim 28, wherein the solid particles and the hollow particles have shapes selected from the group consisting of spheres, fibers, flakes, platelets, and irregular shapes.

30. The materials system of claim 28, wherein the solid material is carbon-bearing.

31. The materials system of claim 1, wherein the solid material is carbon-coated.

32. The materials system of claim 1, further comprising at least two alternating adjacent layers between the second layer and the third layer, the at least two alternating adjacent layers comprising a first alternating layer of the first material and a second alternating layer of the second material.

33. The materials system of claim 1, wherein the third material of the third layer is selected from the group consisting of a porous metal, a porous metallic alloy, and a porous ceramic, and a porous ceramic alloy.

34. The materials system of claim 33, wherein the third layer contains a mixture of the third material and at least an additional material selected from the group consisting of a porous metal, a porous metallic alloy, and a porous ceramic, and a porous ceramic alloy.

35. The materials system of claim 1, wherein the first material of the first layer is porous calcium hexa-aluminate, CaAl₁₂O₁₉, the second material of the second layer is graphite particles, and the third material of the third layer is porous aluminosilicate thermal insulation.

36. The materials system of claim 1, wherein the first material of the first layer is porous magnesium oxide, MgO, the second material of the second layer is graphite particles, and the third material of the third layer is porous aluminosilicate thermal insulation.

37. The device comprising the materials system of claim 1, wherein the device is selected from the group consisting of a pipe, a valve, a seal, and a tank.

38. The device of claim 37, wherein the device is installed in a system selected from the group consisting of a system for electricity generation, a system for energy storage, a system for waste heat recovery, and a system for chemical processing.

39. The device of claim 37, wherein the system for electricity generation is selected from the group consisting of a fossil fuel-based electricity generating system, a solar energy-based electricity-generating system, a hydrothermal energy-based electricity-generating system, and nuclear energy-based electricity generating system.

40. The molten-salt-facing wall comprising the materials system of claim 1.
